(19) United States
(12) Patent Application Publication
(10) Pub. No.: US 2023/0003340 A1
(43) Pub. Date: Jan. 5, 2023

(54) GREASE GUN

(71) Applicant: Pressol-Schmiergeräte Gesellschaft mit Beschränkter Haftung, Umkirch (DE)

(72) Inventor: Rudolf SCHLENKER, Weggis (CH)

(73) Assignee: Pressol-Schmiergeräte Gesellschaft mit Beschränkter Haftung, Umkirch (DE)

(21) Appl. No.: 17/781,493

(22) PCT Filed: Dec. 2, 2020
(86) PCT No.: PCT/EP2020/084294

§ 371 Date: Jun. 1, 2022

(30) Foreign Application Priority Data
Dec. 3, 2019 (DE) 10 2019 132 773.3

(51) Int. Cl. F16N 3/12

(52) U.S. Cl. CPC F16N 3/12

(57) ABSTRACT

A grease gun (1) with improved handling includes a screw coupling (2) for coupling a screw cartridge (7, 8). The screw coupling (2) encompasses at least two different coupling threads (5, 6) for coupling screw cartridges (7, 8) that include different mating threads (9, 10).

### TECHNICAL FIELD

The invention relates to a grease gun with a screw coupling, for coupling a screw cartridge containing lubricant, which leads into a conveying mechanism of the grease gun.

### BACKGROUND

Grease guns are used for the purpose of pressing lubricant, in particular lubricating grease, onto a point of lubrication, for example onto a bearing. To do this, the grease gun can, for instance, be coupled onto a lubricating nipple via which the lubricant conveyed out of the grease gun then reaches the point of lubrication to be lubricated.

### SUMMARY

The object of the invention is to provide a grease gun of the aforementioned type with improved usage properties.

With a view to achieving the object, a grease gun is proposed having the features of the independent claim. In particular, with a view to achieving the object, a grease gun of the aforementioned type is proposed which is characterized in that the screw coupling encompasses at least two different coupling threads for coupling screw cartridges having different mating threads. In this way, it is possible to equip and use one and the same grease gun with different screw cartridges. Consequently, two different grease guns no longer have to be kept available in order to utilize screw cartridges having different types of thread.

The grease gun is connected via its screw coupling to a screw cartridge which contains lubricant. Upon actuation of the grease gun, the lubricant is conveyed out of the screw cartridge and supplied to a point of lubrication via a discharge aperture of the grease gun. In this process, the screw cartridge can optionally be screw-coupled with one of the at least two different coupling threads.

The two coupling threads of the grease gun may have different diameters. Accordingly, screw cartridges with differently dimensioned mating threads can be coupled onto the same grease gun.

Ordinarily, the screw cartridges have been provided with external threads. The coupling threads of the grease gun therefore preferably take the form of internal threads. In this way, a screw cartridge that includes a mating thread taking the form of external thread can be reliably screwed into one of the two coupling threads. The internal threads of the grease gun may have been configured in such a way that they overlap threaded nozzles of the screw cartridges, on which the mating threads have been formed, when the screw cartridges have been properly connected to the grease gun.

The at least two coupling threads may have been arranged one inside the other and, in particular, concentrically with respect to one another. Furthermore, they may surround, preferentially concentrically, an outlet aperture of the screw coupling into a conveying connection of the conveying mechanism toward a discharge aperture of the grease gun. In this way, it is ensured that lubricant from the screw cartridge can reach the conveying mechanism of the grease gun, regardless of the coupling thread, of the at least two coupling threads of the grease gun, via which a screw cartridge has been coupled onto the grease gun.

The screw coupling of the grease gun may include at least two threaded nozzles. One of the at least two coupling threads may have been arranged or formed on each of the threaded nozzles. The at least two threaded nozzles have preferentially been arranged one inside the other. Particularly preferably, the at least two threaded nozzles have been arranged concentrically with respect to one another. Furthermore, the threaded nozzles may concentrically surround an outlet aperture—for instance, the outlet aperture already mentioned previously—of the screw coupling through which lubricant can reach the conveying mechanism of the grease gun.

The at least two coupling threads of the grease gun have preferably been nested one inside the other in such a way that they terminate flush on the cartridge side. Furthermore, free, cartridge-side end faces of the at least two coupling threads may have been arranged in a common plane. Accordingly, the at least two different coupling threads of the screw coupling of the grease gun can be accessible for the mating threads of different types of screw cartridge. This can favor the reliable coupling of cartridges onto the grease gun.

In one embodiment of the grease gun, the latter takes the form of a single-lever grease gun. In another embodiment of the grease gun, the latter takes the form of a double-lever grease gun.

### BRIEF DESCRIPTION OF THE DRAWINGS

The invention will now be described in more detail with reference to an embodiment example, but it is not restricted to this embodiment example. Further embodiment examples result by combining the features of individual or several claims for protection with one another, and/or by combining individual or several features of the embodiment example. Shown are:

FIG. 1 a perspective side view of a grease gun,

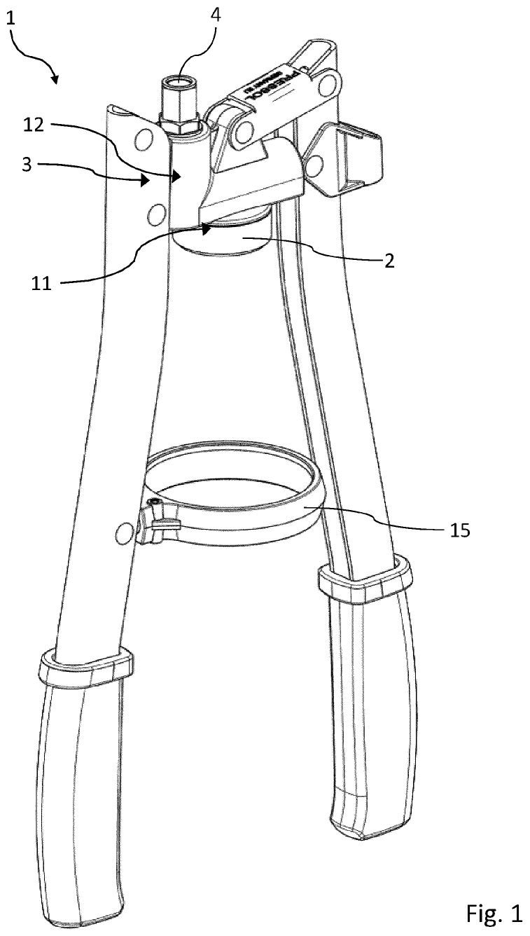

FIG. 2 a partially broken-away side view of the grease gun from FIG. 1 with a screw cartridge coupled onto an inner coupling thread of two coupling threads of the grease gun, and

FIG. 3 a partially broken-away side view of the grease gun from FIGS. 1 and 2 with a screw cartridge coupled onto an outer coupling thread of two coupling threads of the grease gun.

### DETAILED DESCRIPTION

All the figures show a grease gun designated in its entirety by 1. The grease gun 1 includes a screw coupling 2 for coupling a screw cartridge. The screw coupling 2 leads into a conveying mechanism 3 of the grease gun 1. With the aid of the conveying mechanism 3, lubricant can be conveyed out of a discharge aperture 4 of the grease gun 1 and supplied to a point of lubrication.

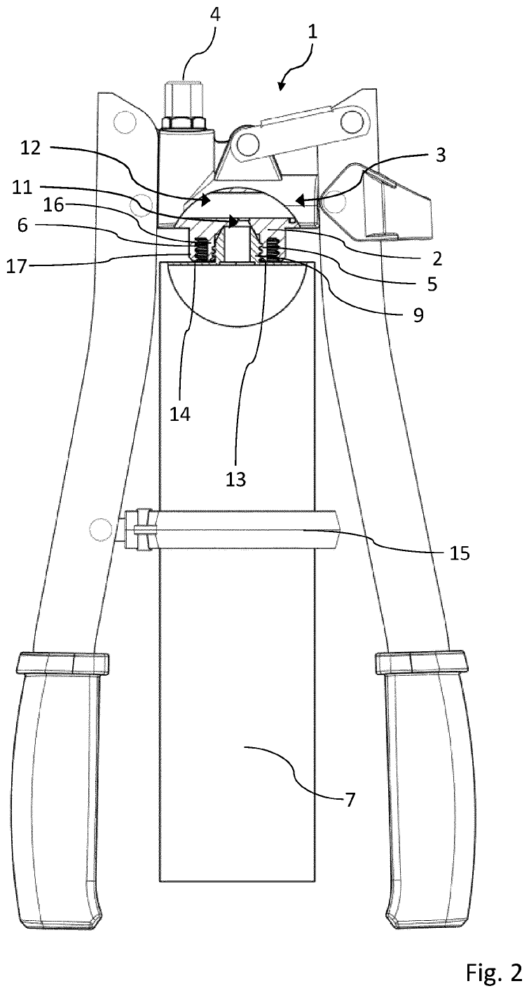

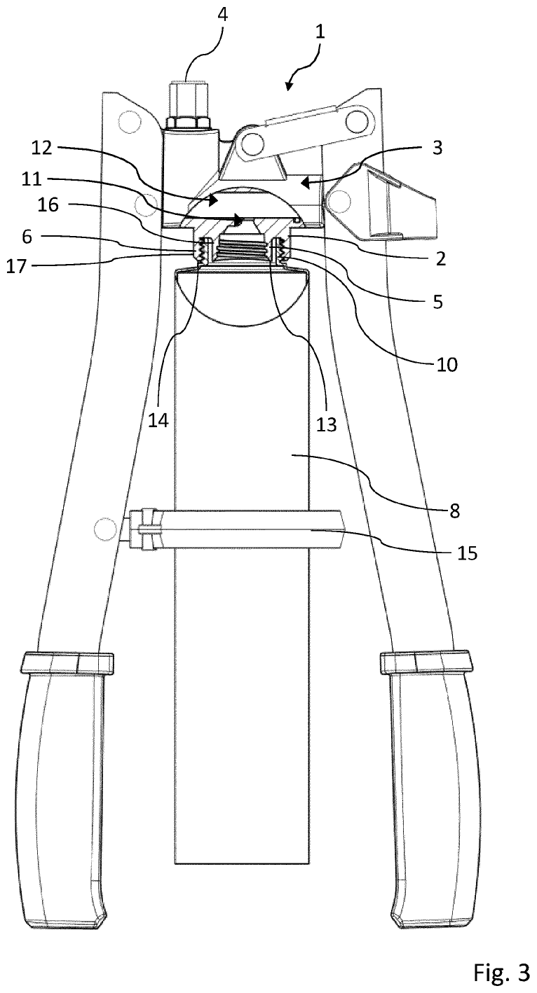

A comparison of FIGS. 2 and 3 makes it clear that the screw coupling 2 encompasses a total of two different coupling threads 5 and 6 for coupling screw cartridges 7 and 8 having different mating threads 9 and 10.

The two coupling threads 5 and 6 differ by virtue of their diameters and take the form of internal threads. The mating threads 9 and 10 of the two screw cartridges 7 and 8 correspondingly take the form of external threads. FIG. 2 shows screw cartridge 7 with the smaller mating thread 9 in the inner coupling thread 5 with the smaller diameter. FIG. 3 shows screw cartridge 8 with its larger mating thread 10 in the larger coupling thread 6 of the grease gun 1.

The partially broken-away representations of the grease gun 1 according to FIGS. 2 and 3 show that the two coupling threads 5 and 6 have been arranged one inside the other and concentrically with respect to one another and concentrically with respect to an outlet aperture 11 of the screw coupling 2 of the grease gun 1. The outlet aperture 11 of the screw coupling 2 leads into a conveying connection 12. Via the conveying connection 12, the outlet aperture 11 of the screw coupling 2 has been connected to the discharge aperture 4 of the grease gun 1.

The screw coupling 2 of the grease gun 1 includes two threaded nozzles 16 and 17. Threaded nozzle 16 is an inner threaded nozzle and includes the inner coupling thread 5. Threaded nozzle 17 is an outer threaded nozzle and includes the outer coupling thread 6 of the two coupling threads 5 and 6. The inner threaded nozzle 16 has been arranged within the outer threaded nozzle 17. In each instance, one of the two coupling threads 5 and 6 has consequently been formed on each of the threaded nozzles 16 and 17. The two threaded nozzles 16 and 17 have been arranged concentrically with respect to one another. Furthermore, the threaded nozzles 16 and 17 concentrically surround the outlet aperture 11, already mentioned previously, of the screw coupling 2. Through the outlet aperture 11, the lubricant—as a rule, lubricating grease—reaches the conveying mechanism 3 of the grease gun 1 from the respectively screwed-in screw cartridge 7 or 8 when the grease gun 1 is actuated, and is finally discharged via the discharge aperture 4.

The two coupling threads 5 and 6 and the two threaded nozzles 16 and 17 have been nested one inside the other in such a way that they terminate flush on the cartridge side. Accordingly, free, cartridge-side end faces 13 and 14 of the two coupling threads 5 and 6 and of the two threaded nozzles 16 and 17 are situated in a common imaginary plane.

The grease gun 1 shown in the figures takes the form of a double-lever grease gun. On one of the two levers the grease gun 1 includes a holder 15 for the screw cartridge 7 or 8.

The invention is concerned with improvements in the technical field of grease guns. In order to improve the handling of a grease gun 1, the latter includes a screw coupling 2 for coupling a screw cartridge 7 or 8. The screw coupling 2 encompasses at least two different coupling threads 5 and 6 for coupling screw cartridges 7 and 8 that include different mating threads 9 and 10.

### LIST OF REFERENCE SYMBOLS

1 grease gun

2 screw coupling

3 conveying mechanism

4 discharge aperture

5 inner coupling thread

6 outer coupling thread

7 screw cartridge

8 screw cartridge

9 mating thread on 7

10 mating thread on 8

11 outlet aperture of 2

12 conveying connection

13 end face of 5

14 end face of 6

15 holder

16 inner threaded nozzle

17 outer threaded nozzle

1. A grease gun (1), comprising:
a screw coupling (2) configured for coupling a screw cartridge (7, 8), the screw coupling (2) leads into a conveying mechanism (3) of the grease gun (1), and the screw coupling (2) has at least two different coupling threads (5, 6) configured for coupling screw cartridges (7, 8) having different mating threads (9, 10).

2. The grease gun (1) as claimed in claim 1, wherein the at least two coupling threads (5, 6) have different diameters.

3. The grease gun (1) as claimed in claim 1, wherein the at least two coupling threads (5, 6) comprise internal threads.

4. The grease gun (1) as claimed in claim 1, wherein the at least two coupling threads (5, 6) are arranged one inside the other.

5. The grease gun (1) as claimed in claim 1, wherein the screw coupling (2) includes at least two threaded nozzles (16, 17) on which, in each instance, one of the at least two coupling threads (5, 6) is arranged or formed.

6. The grease gun (1) as claimed in claim 1, wherein the at least two coupling threads (5, 6) are nested one inside the other such that the at least two coupling threads terminate flush on the cartridge side.

7. The grease gun (1) as claimed in claim 1, wherein the grease gun (1) is a single-lever grease gun or a double-lever grease gun.

8. The grease gun (1) of claim 1, wherein the at least two coupling threads are arranged concentrically with respect to one and surround an outlet aperture (11) of the screw coupling (2) into a conveying connection (12) of the conveying mechanism (3) toward a discharge aperture (4) of the grease gun (1).

9. The grease gun (1) of claim 5, wherein the at least two threaded nozzles (16,

17. are arranged at least one of one inside the other or concentrically with respect to one another, and concentrically surround an outlet aperture (11) of the screw coupling (2).

10. The grease gun (1) of claim 6, wherein free, cartridge-side end faces (13, 14) of the at least two coupling threads (5, 6) are arranged in a common plane.
